(19) United States
(12) Patent Application Publication
(10) Pub. No.: US 2026/0001784 A1
(43) Pub. Date: Jan. 1, 2026

(54) GATE-ALL-AROUND AND MULTI-GATE ION CONCENTRATION POLARIZATION FOR DESALINATION

(71) Applicant: Mohammad Najmzadeh, San Jose, CA (US)

(72) Inventor: Mohammad Najmzadeh, San Jose, CA (US)

(21) Appl. No.: 19/097,585

(22) Filed: Apr. 1, 2025

Related U.S. Application Data
(60) Provisional application No. 63/665,132, filed on Jun. 27, 2024.

(51) Int. Cl. C02F 1/26; C02F 103/08

(52) U.S. Cl. CPC C02F 1/265; C02F 2103/08; C02F 2201/46115; C02F 2201/46145; C02F 2301/08

(57) ABSTRACT

A desalination apparatus comprises a fluid pathway having an inlet configured to receive salt water. A part of microfluidic channel is fluidly connected to the fluid pathway. At least one ion exchange membrane (IEM) gate is positioned in a Gate-All-Around (GAA) or a Multi-Gate (MG) configuration around the gated region of the microfluidic channel. At least first and second outlets of the fluid pathway are provided, wherein the GAA or MG ion exchange membrane is positioned between the first outlet and the inlet, wherein dilute of the salt water is expelled through the first outlet and concentrated brine of the salt water is expelled through the second outlet.

### CROSS REFERENCE TO RELATED APPLICATION

This application claims benefit of U.S. Provisional Application Ser. No. 63/665,132 entitled, “Gate-all-around and multi-gate ion concentration polarization devices for desalination” filed Jun. 27, 2024, the entire disclosure of which is incorporated herein by reference.

### FIELD OF THE DISCLOSURE

The present disclosure is generally related to desalination and more particularly is related to gate-all-around and multi-gate ion concentration polarization devices, systems, and methods for desalination.

### BACKGROUND OF THE DISCLOSURE

Desalination of sea water and other water having a salinity content can be achieved in commercial plants using either thermal evaporation or reverse osmosis (RO). The RO process consumes high energy due to the requirement to push sea water through a membrane. In order to overcome the osmotic pressure, a high-pressure pump is used. The RO system has a high maintenance cost due to the requirement to change the membrane regularly. The thermal evaporation methods of desalination also consume high energy and the cost depends on the fuel price for generating heat. Thermal evaporation methods also suffer from scalability issues, in that, they typically require plant-sized factories and are not suitable for smaller applications, such as small-sized residential applications.

Several ion migration methods have been proposed as potential methods to reduce power consumption and also eliminate the maintenance cost in desalination systems. These include, for instance, electrodialysis (ED), electrodeionization (EDI), capacitive deionization (CDI) and Ion Concentration Polarization (ICP). These electric desalination techniques do not push water through a membrane, in contrary to reverse-osmosis, and therefore, they should have substantially lower maintenance costs. While some ion migration products have been introduced to the desalination market for desalination of brackish water, they typically show significant deficiencies to desalinate sea water.

FIG. 1 is an example of a traditional ICP desalination device 2 with single-gate and with single-grounding, in accordance with the prior art. As shown, salt water enters the ICP desalination device 2 via inlet stream 3. The salt water input of inlet stream 3 is electrically biased at V+ voltage while a nanojunction 9 is electrically grounded. The nanojunction 9 can transport only cations but not anions (selective to the charge type) and NAFION® is typically used for such demonstrations. By applying a sufficient electric field, an ion depletion zone gets formed, resulting an ion depletion boundary 5. The ions and charged particles get repelled electrically at the ion depletion boundary 5 and the net force of hydrodynamic pressure due to inlet stream 3 and repelling electrostatic force re-route them to the concentrate brine stream 6. Therefore, it results a desalinated water stream 7. The concentrate brine stream 6 and the desalinated stream 7 are positioned at an acute angle 8. Note that in the traditional prior art devices, as shown in FIG. 1, the acute angle was used between the concentrate brine stream 6 outlet and sea water inlet stream 3, considering the net force direction of inlet-driven hydrodynamic flow and the electrostatic repulsion at the ion depletion boundary 5. Additionally, with these prior art devices, the nanojunction 9 was used either as a back-gate, or as a side-gate with a very long parasitic tail across the entire of both desalted and concentrate brine streams which can capture significant amount of parasitic leakage current.

Thus, a heretofore unaddressed need exists in the industry to address the aforementioned deficiencies and inadequacies.

### SUMMARY OF THE DISCLOSURE

Embodiments of the present disclosure provide an apparatus, system, and method for desalination. Briefly described, in architecture, one embodiment of the apparatus, among others, can be implemented as follows. A fluid pathway has an inlet configured to receive salt water. A microfluidic channel is fluidly connected to the fluid pathway. At least one ion exchange membrane is positioned in a Gate-All-Around (GAA) or a Multi-Gate (MG) configuration around a gated region of microfluidic channel. At least first and second outlets of the fluid pathway are provided, wherein the GAA or MG ion exchange membrane is positioned between the first outlet and the inlet, wherein dilute of the salt water is expelled through the first outlet and concentrated brine of the salt water is expelled through the second outlet.

The present disclosure can also be viewed as providing a multi-stage desalination system. Briefly described, in architecture, one embodiment of the system, among others, can be implemented as follows. A first desalination apparatus is in fluid communication with a second desalination apparatus. Each of the first desalination apparatus and second desalination apparatus have: a fluid pathway having an inlet configured to receive salt water; a microfluidic channel fluidly connected to the fluid pathway; at least one ion exchange membrane positioned in a Gate-All-Around (GAA) or a Multi-Gate (MG) configuration around a gated region of microfluidic channel; and at least first and second outlets of the fluid pathway, wherein the GAA or MG ion exchange membrane is positioned between the first outlet and the inlet, wherein dilute of the salt water is expelled through the first outlet and concentrated brine of the salt water is expelled through the second outlet.

The present disclosure can also be viewed as providing methods of desalination. In this regard, one embodiment of such a method, among others, can be broadly summarized by the following steps: receiving salt water in an inlet of a fluid pathway; separating ions in the salt water at a microfluidic channel fluidly connected to the fluid pathway with at least one ion exchange membrane positioned in a Gate-All-Around (GAA) or a Multi-Gate (MG) configuration around a gated region of microfluidic channel; expelling dilute of the salt water through a first outlet, wherein the GAA or MG ion exchange membrane is positioned between the first outlet and the inlet; and expelling concentrated brine of the salt water through a second outlet.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an example of an ICP desalination device with single-gate and single-grounding, in accordance with the prior art.

FIG. 2 is a side, diagrammatical illustration of the desalination apparatus, in accordance with embodiments of the present disclosure.

FIG. 3 is a cross-sectional, diagrammatical illustration of the desalination apparatus of FIG. 2, in accordance with embodiments of the present disclosure.

FIGS. 4A-4J are cross-sectional, diagrammatical illustrations of the ion exchange membrane of the desalination apparatus of FIG. 2 positioned in various GAA or MG configurations, in accordance with embodiments of the present disclosure.

FIG. 5 is a side, diagrammatical illustration of a multi-stage desalination apparatus, in series operation configuration, in accordance with embodiments of the present disclosure.

FIG. 6 is a side, diagrammatical illustration of a multi-stage desalination apparatus, in parallel operation configuration, in accordance with embodiments of the present disclosure.

FIG. 7A illustrates an exemplary top view of a desalination apparatus fabricated using polydimethylsiloxane (PDMS), silicon or the other materials, in accordance with one example of the present disclosure.

FIG. 7B illustrates an exemplary cross-sectional view of FIG. 7A along the line A-A′, depicting a three-gate device with double-grounding, in accordance with one example of the present disclosure.

FIG. 7C illustrates an exemplary cross-sectional view of FIG. 7A along the line A-A′, depicting a four-gate device with double-grounding, in accordance with one example of the present disclosure.

FIG. 8 is an illustration of a fabricated four-gate device with a localized nanopore within PDMS, in accordance with one example of the present disclosure.

FIG. 9 is a graphical illustration depicting a normalized current to a limiting current versus voltage characteristics of a four-gate device versus a traditional single-gate device, with both devices having double-grounding, in accordance with one example of the present disclosure.

FIG. 10 is a flowchart illustrating a method of desalination, in accordance with the present disclosure.

### DETAILED DESCRIPTION

To improve over the shortcomings of the prior art, this disclosure is directed to desalination of salt water such as from the sea or ocean, or another body of water, or desalination of brackish water or any other water which has a salt content (hereinafter referred to for simplicity as “salt water”). Desalination can be achieved using Gate-All-Around (GAA) and Multi-Gate (MG) Ion Concentration Polarization (ICP) devices. As will be explained, a selective ion exchange membrane (IEM) to either cations or anions, may be placed on multiple or all side-walls of the gated region of a microfluidic channel. By applying a proper electrical bias scheme to such microfluidic device, it is possible to create a fully depleted (FD) microfluidic channel, which has an ion depletion zone (IDZ) across the entire cross-section of the gated region of the microfluidic channel. The ions and charged particles in the salt water flow, which entered to the microfluidic device from the inlet, get repelled nearby the FD microfluidic channel and re-routed to the concentrate brine outlet. As a result, only the dilute water can enter to the FD microfluidic channel region. This dilute water gets collected in the dilute outlet and can be used or can be further refined, as needed.

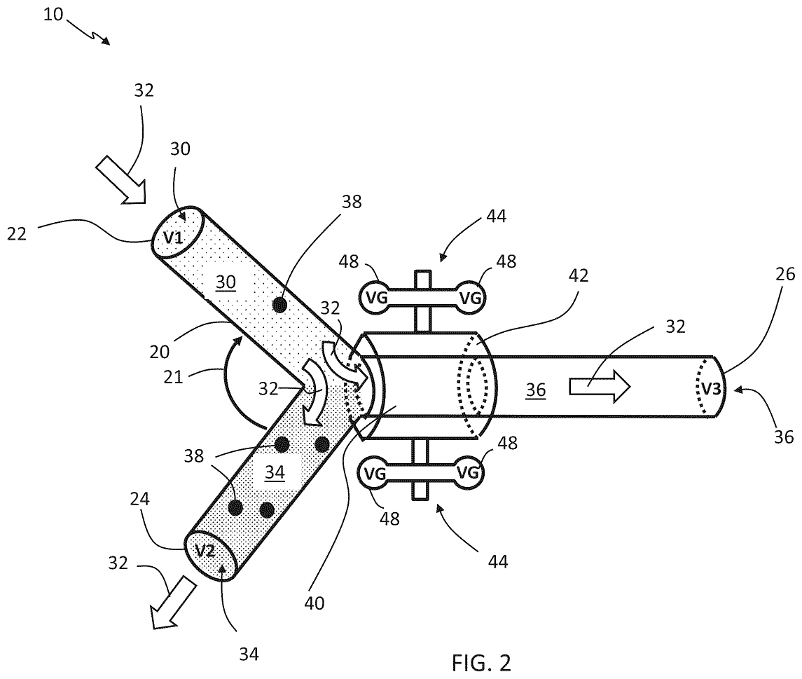

FIG. 2 is a side, diagrammatical illustration of the desalination apparatus 10, in accordance with embodiments of the present disclosure. The desalination apparatus 10, which may be referred to simply as ‘apparatus 10’ includes a fluid pathway 20 having an inlet 22 configured to receive salt water 30. The fluid pathway 20 may include any type of vessel or containment unit for transporting or holding fluid, such as a pipe, a conduit, or a similar vessel. The inlet 22 of the fluid pathway 20 may be positioned proximate to the salt water, such as in or near an ocean or other body of water, or it may be connected with another device to the supply of water, such as a network of pipes and pumps, or a transportation vessel.

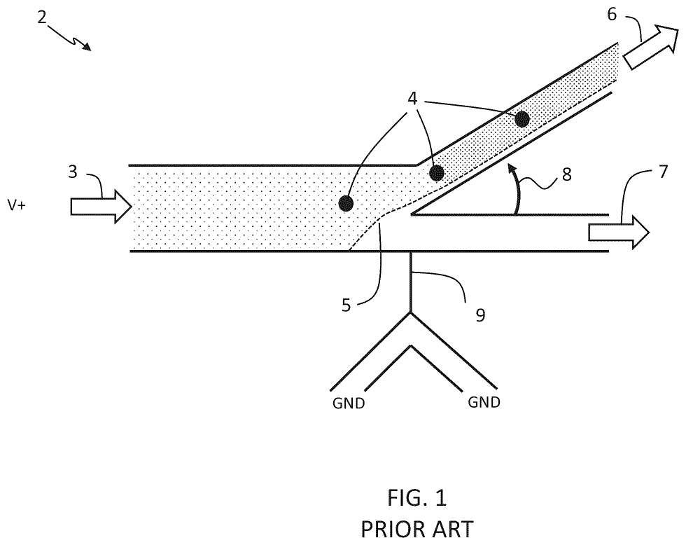

Throughout the fluid pathway 20, the salt water 30 may flow in the direction of flow arrow 32, as shown in FIG. 2, where the flow moves from the inlet 22 to either the gated region of a microfluidic channel 40, which leads to the direction of a dilute outlet 26, or to the direction of a concentrate brine outlet 24. The inlet 22, two outlets (concentrate brine outlet 24 and dilute outlet 26) and the gated region of the microfluidic channel 40 are fluidly connected to the fluid pathway 20. The direction of fluid flow along the fluid pathway 20 from the inlet 22 with an angle 21 to a direction of fluid flow along the fluid pathway 20 between the microfluidic channel 40 and the concentrated brine outlet 24. The angle 21 can be perpendicular, 90° angle, acute or non-acute, and the system 10 may provide such flexibility in the angle 21 measurement versus the traditional prior art with an acute angle, such as is depicted in FIG. 1. The angle between the concentrate brine outlet 24 and the gated region of the microfluidic channel 40 may ideally be in the direction of net force of hydrodynamic pressure of sea water stream flow arrow 32 and the repelling electrostatic forces at the gated region of microfluidic channel 40. The gated region of the microfluidic channel 40 may be understood as the portion of the microfluidic channel 40 which is interior of at least one ion exchange membrane (IEM) gate 42, and is acted on by the electro-fluidic connections 44. In the example of FIG. 2, the gated region exists beginning at a junction between fluid pathway 20 and the microfluidic channel 40, and extends substantially along a length of the IEM gate 42 towards outlet 26.

The inlet 22 is electrically biased to the voltage of V1 and the gated region of the microfluidic channel 40 is electrically biased to the voltage of VG. The concentrate brine outlet 24 is electrically biased to the voltage of V2. The dilute outlet 26 is electrically biased to the voltage of V3. By applying a specific voltage bias scheme to V1, V2, V3 and VG, the gated region of microfluidic channel 40 may be considered fully depleted (FD), such flow of water can occur through the gated region of microfluidic channel 40, while the ions and charged particles in the sea water flow are repelled from the gated region of microfluidic channel 40 and they must go towards the concentrate brine outlet 24.

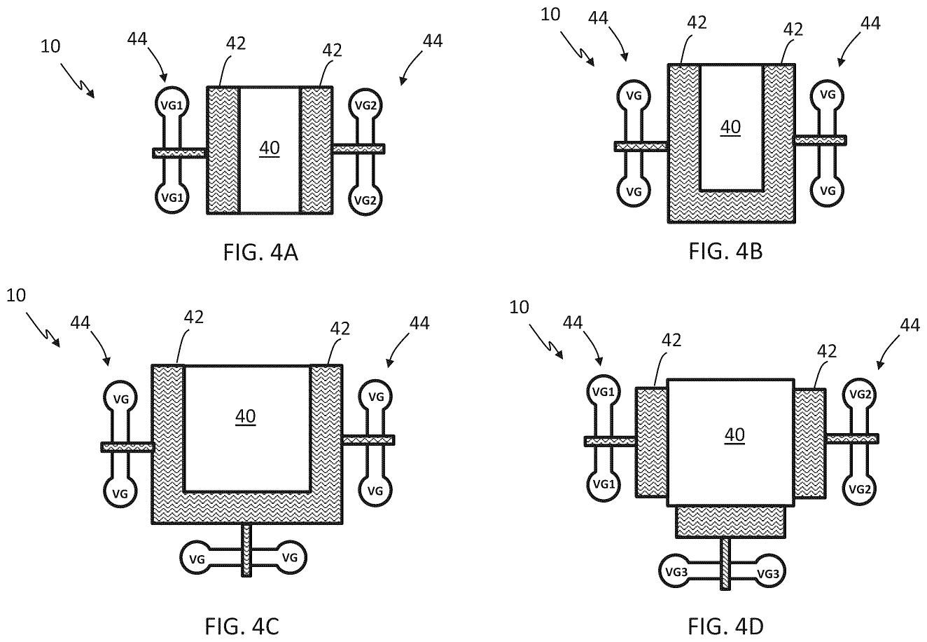

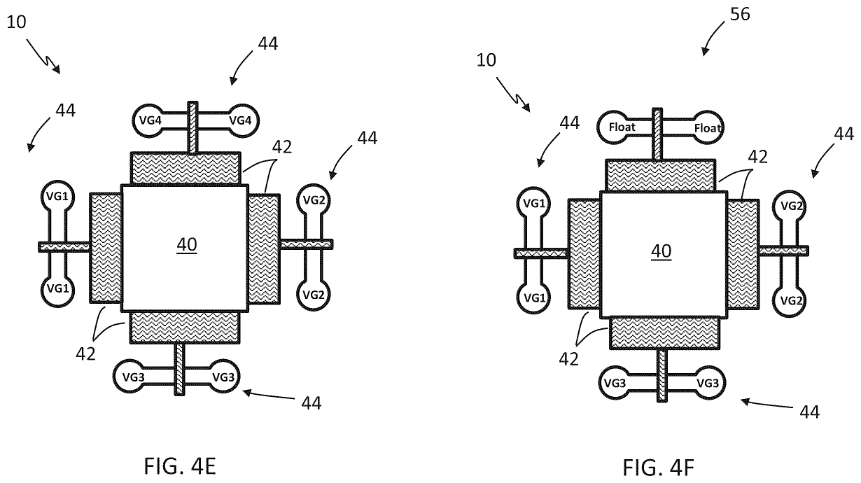

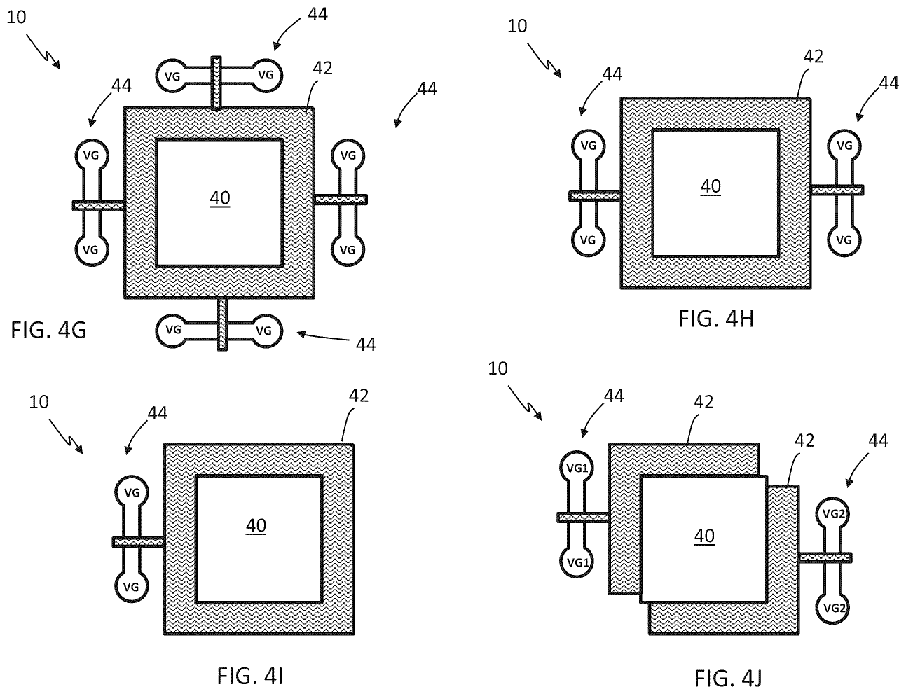

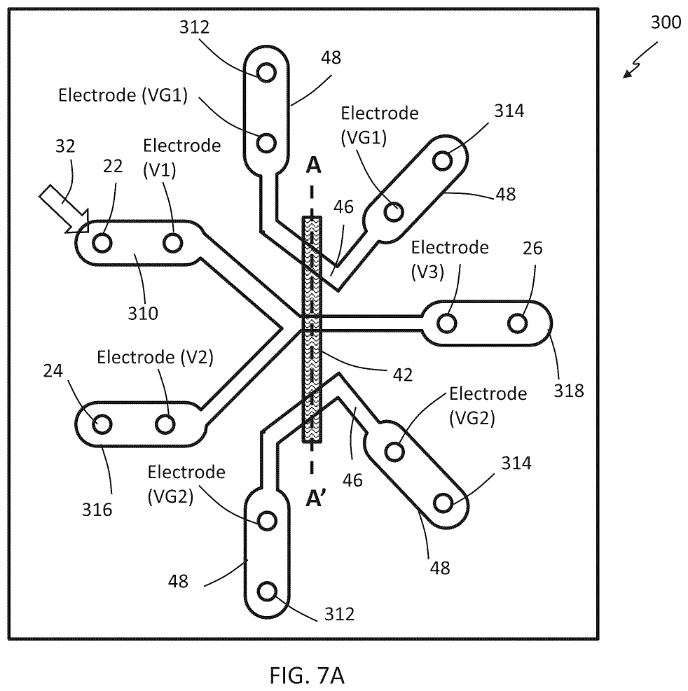

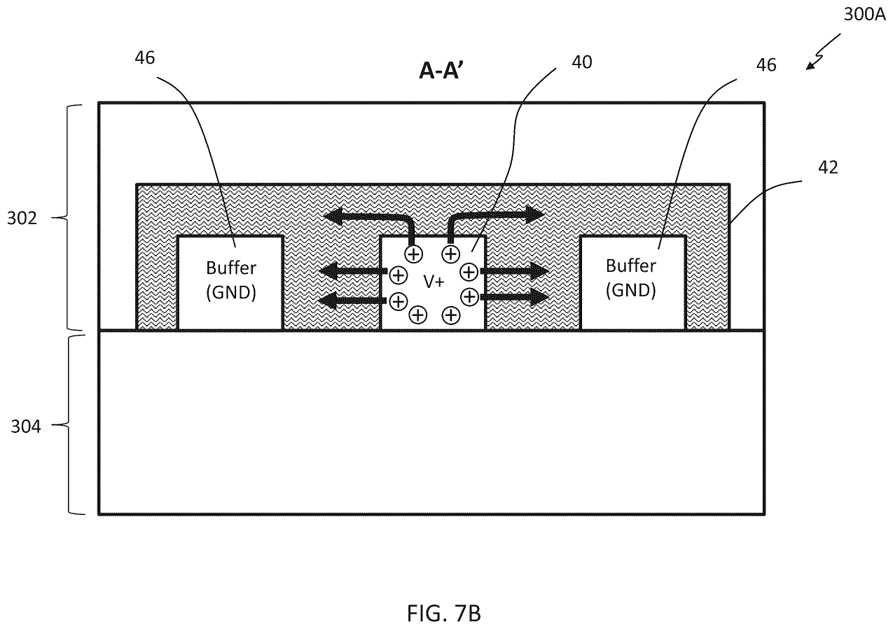

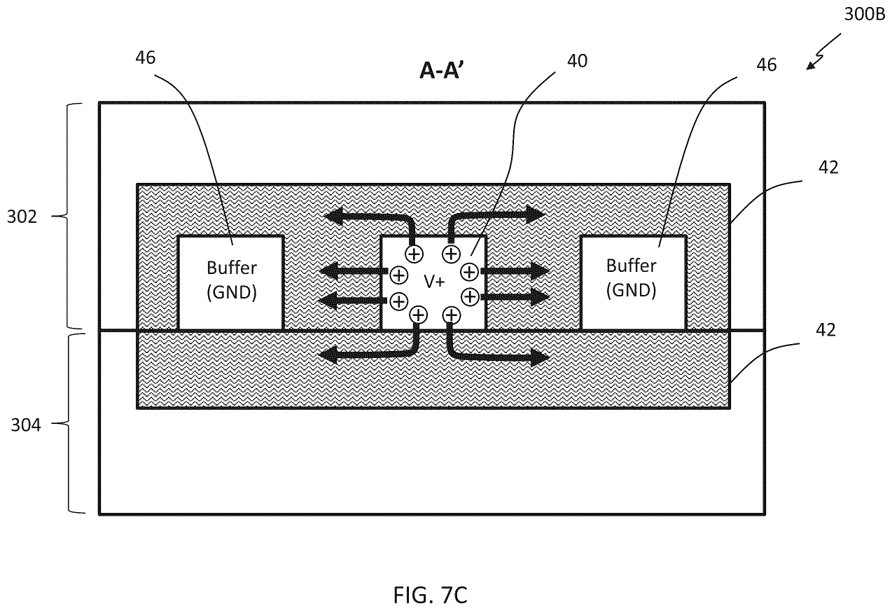

At least one IEM gate 42 is positioned in a GAA or a MG configuration around the gated region of microfluidic channel 40. In FIG. 2, the IEM gate 42 is illustrated in the GAA configuration, as the IEM gate 42 is positioned fully surrounding or around the gated region of microfluidic channel 40 along a direction of flow of the fluid through the microfluidic channel 40, e.g., such that it is positioned on all radial sides of the gated region of microfluidic channel 40 without physically inhibiting fluid flow. In the MG configuration, the IEM gate 42 is positioned surrounding or around some portion less than the entire circumference of the perimeter of the gated region of microfluidic channel 40, such as along at least two sides of the gated region of microfluidic channel 40 along a direction of flow of the fluid through the microfluidic channel 40. Examples of the MG configuration are depicted in FIGS. 4A-4F, 4J, and 7B. The microfluidic pathways between inlet 22 and two outlets (concentrate brine outlet 24, dilute outlet 26) may be constructed or fabricated using polymers (such as PDMS), silicon, oxides/nitrides or the other materials.

The gated region of microfluidic channel 40 is positioned in a fluid path between the inlet 22 and the dilute outlet 26 and proximate to the fluid path of the inlet 22 to the concentrated brine outlet 24, such that fluid which gets expelled from the dilute outlet 26 must pass through the gated region of microfluidic channel 40. In operation, salt water 30 ingested into the fluid pathway 20 is moved to a location proximate to the gated region of microfluidic channel 40, where the salt in the salt water is repelled from the gated region of microfluidic channel 40, thereby causing the concentrated brine 34 to move away from the gated region of microfluidic channel 40 and therefore, move towards the concentrated brine outlet 24 of the fluid pathway 20. The concentration of salt in the concentrated brine 34 results in a portion of the salt water 30 to be desalinated, partially or fully, which generates the dilute 36. The dilute 36 is expelled through the dilute outlet 26, thereby effectively providing desalinated water from the salt water 30.

In further detail, the use of the gated region of microfluidic channel 40 with the IEM gate 42 positioned in the GAA or MG configurations provides a GAA and/or an MG ICP device. The designs include placement of an IEM gate 42 on multiple or all side-walls of the gated region of microfluidic channel 40, which allows creation of the FD gated region of microfluidic channel 40 in the gated region of the apparatus 10. The IEM gate 42 can be cation exchange membrane (CEM) or anion exchange membrane (AEM). Electrical biasing of the gated region of microfluidic channel 40 may be achieved through one or more electro-fluidic connections 44 on each side of the gated region of microfluidic channel 40. The electro-fluidic connections 44 can get electrically biased together or they can get electrically biased independently. Some of the electro-fluidic connections 44 may be electrically biased and some may be electrically floated (not connected to any voltage source), depending on the ways that the reservoirs 48 get biased electrically. The gated region of microfluidic channel 40 may have various shapes and sizes, and may include cross-sections which are triangular, rectangular, circular or have any regular or irregular cross-section. The IEM gate 42 exterior shape may or may not follow the gated region of microfluidic channel 40 cross-section shape, but the presence of the IEM gate 42 on at least multiple side-walls of the gated region of microfluidic channel 40 allows enhancement of the electrostatic forces to create a full depletion across the entire cross-section of the gated region of microfluidic channel 40.

In operation, the GAA and MG configurations of the IEM gate 42 can have a single bias voltage on all the side-walls of the IEM gates 42 (e.g., if all the side-walls of the IEM gates 42 are physically connected), or a portion of the side-walls of the IEM gates 42 may get biased independently (e.g., if they are not physically connected). The electrical terminals of this microfluidic device (V1, V2, V3, VG) can get electrically biased in multiple ways to be able to create the FD gated region of microfluidic channel 40 of the apparatus 10. Some electrical terminals of V1, V2, V3 might get electrically floated and not electrically biased.

One bias scheme example to create an FD device in case of using a GAA-CEM can be a positive voltage (V+) on the inlet 22 (V1=V+), the IEM gate 42 is grounded using electro-fluidic connections 44 (VG=GND), the concentrated brine outlet 24 is floated electrically (V2=float), and the dilute outlet 26 is floated electrically (V3=float). This example is based on the assumption that the apparatus 10 is used to desalinate sea water, including ions and charged particles 38. The sea water can get mechanically pushed through the inlet 22 using pump, gravity or the other methods. One charge type of ion or particle cannot enter the full depletion region of the gated region of microfluidic channel 40, due to the combined repelling electrostatic forces from all the side-walls of the IEM gate 42 of the GAA or MG architecture. Afterward, it gets re-routed to the concentrated brine 34, due to the net force of electrostatics and hydrodynamics (in case of a GAA-CEM device, the anions cannot enter the FD gated region of microfluidic channel 40 due to repelling electrostatic forces from all the side-walls of the IEM gate 42). To keep the charge neutrality in the fluidic flows in the outlets, all the ions and the charged particles, independent of charge type, would get re-routed to the concentrated brine outlet 24 and the dilute water 36 gets collected at the dilute outlet 26.

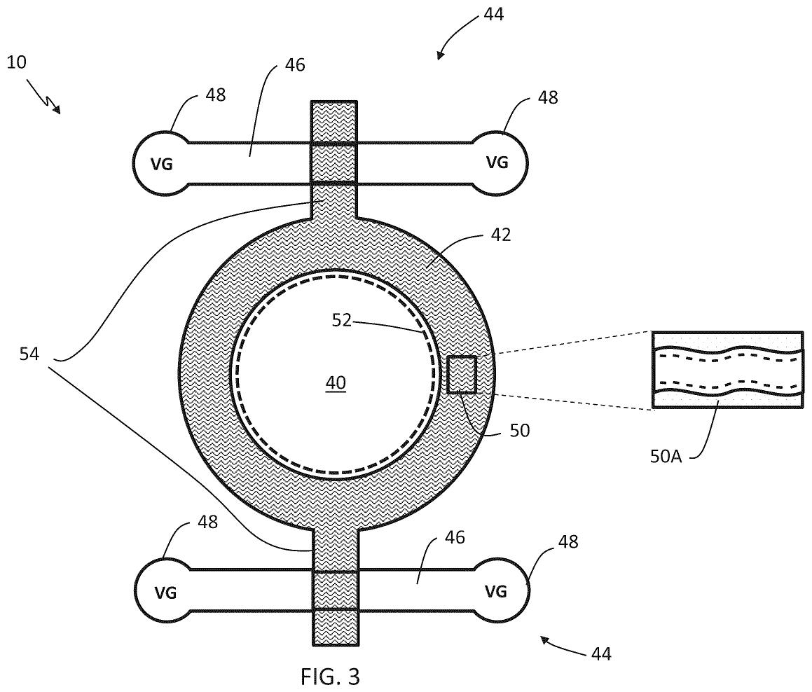

The IEM gate 42, which may also be referred to in the industry as a nanojunction, which is used in the GAA and MG configuration may be a nanoporous material with high fixed surface charges. Examples of such IEM gate 42 nanoporous material can be polymer thin films (such as NAFION® for CEM and SUSTAINION® for AEM), silicon nanostructures or the other types of nanoporous organic/inorganic structures. The IEM gate 42 nanoporous material for sea water desalination may have an ultra-small pore size in nanometer scale (e.g. sub-10 nm) and a high surface charge density on the side-walls of the nanopores to be able to transport only one ion charge type (e.g. cation only) and repel completely one ion charge type (e.g. anion only), due to Donnan equilibrium. Therefore, a strong selectivity to one charge type of ion by the IEM gate 42 may be needed for sea water desalination. Note that in case of using CEM as the IEM gate 42, the surface charges on the side-walls of the nanoporous channel, as well as the surface charges 52 (FIG. 3) on the side-walls of the gated region of microfluidic channel 40, would be negative (repelling anions) and in case of using AEM as the IEM gate 42, such surface charges would be positive (repelling cations).

FIG. 3 is a cross-sectional, diagrammatical illustration of the desalination apparatus 10 of FIG. 2, in accordance with embodiments of the present disclosure. With reference to FIGS. 2-3 together, it is noted that the IEM gate 42 in the GAA or MG configuration requires both fluidic and electrical connections. The electro-fluidic connection 44 has an internal buffer 46 electrolyte solution while its one or two reservoirs 48 would get used to apply electrical biases. The internal buffer 46 electrolyte solution should have a controlled pH, concentration and ionic strength to optimize the IEM gate 42 electrical properties, selectivity, and therefore, create a controlled FD gated region of microfluidic channel 40, and it is separated from the main desalination liquid flow. The internal buffer 46 electrolyte solution can be stagnant (no flow) or with a slight flow to refresh the buffer electrolyte solution at all locations in the GAA or MG nanoporous membrane gate. To optimize the FD channel formation, double or multiple electro-fluidic connections 44 may get used for the GAA or MG IEM nanoporous membranes.

FIG. 3 specifically illustrates the use of a nanoporous CEM 50 as an IEM gate 42 which is placed on all side-walls of the gated region of microfluidic channel 40 to create a GAA-CEM. A CEM 50 has nanopores with negative surface charges on all side-walls of the nanopore side-walls, as shown in the enlarged cutout of the CEM 50A depicted in FIG. 3. The negative surface charges 52 are also present on the side-walls of the gated region of microfluidic channel 40. In this structure, the anions cannot enter or transport via the CEM nanopores, due to Donnan equilibrium, while the anions also cannot enter an FD gated region of microfluidic channel 40, due to the combined electrostatic forces between all the side-walls of the IEM gates 42 and the anion. The GAA-CEM requires electro-fluidic connection 44 for electrical biasing, with typically two reservoirs 48 on each side of the buffer 46 electrolyte solution channel. Single or multiple electro-fluidic connections 44 may get used around a GAA-CEM. The buffer 46 electrolyte solution in the electro-fluidic connection can be stagnant (no flow) or with a slight flow. In each electro-fluidic connection, one or both reservoirs 48 may get electrically biased.

With reference to FIGS. 2-3, the electrical connections to the inlet 22, the concentrate brine outlet 24, the dilute outlet 26 and the reservoirs 48 may be achieved using platinum electrodes, or any other metals or electrical conductors or interconnects, or electrochemical electrodes such as Ag/AgCl. The two electrodes that may be used to apply electrical biases to the reservoirs 48 may be connected together in the device level or may stay separated. FIG. 3 depicts the CEM interconnect 54 for the electro-fluidic connection to the CEM 50 in the GAA configuration. It is noted that only the IEM gate 42 requires electro-fluidic connection but not the inlet 22, concentrate brine outlet 24 and dilute outlet 26. The electrical connection to inlet 22, concentrate brine outlet 24 and dilute outlet 26 may be done using reservoirs, with electrodes inside, or using electrodes along the fluid pathway 20 nearby each inlet 22, concentrate brine outlet 24 or dilute outlet 26.

The apparatus 10 may operate in either full depletion or in partial depletion (PD). Full depletion may be used for ultimate desalination of sea water to provide ultra-pure water while partial depletion may be used to tune the concentration in the dilute outlet to be able to meet requirements without full desalination. Note that partial desalination might be sufficient for several purposes such as agriculture, while ultra-pure water is only required for specific industries such as semiconductor or chemical industries.

In operation, the apparatus 10 provides substantial improvements over current desalination technology. In conventional ICP devices, the IEM or nanojunction is placed only on one side-wall of a microfluidic channel to create an FD microfluidic channel. Some conventional devices suggest the use of a double-gate (or dual-gate) for water desalination purposes, but they utilize a flat IEM on only one side-wall of the microfluidic channel while they performed dual-grounding (or double-grounding) on both ends of the IEM. Effectively such conventional devices act as a single-gate (SG) device, with double-grounding, and a high voltage is required to create an FD microfluidic channel. There are a few devices which demonstrated placing an IEM on both side-walls of the gated region of the microfluidic channel, but all such devices focus on preconcentration of ions/particles/biomolecules and are not used for desalination. In particular, the double-gates were placed at the middle of a microfluidic channel for only preconcentration purposes, without including the two required outlets in the device to be able to create two separate dilute and concentrated brine flows from the main sample flow.

Beyond desalination of salt water, the apparatus 10 may be used for other purposes, as desired. For instance, other applications of the apparatus 10 may include, but are not limited to, various water desalination (residential, commercial, brackish/sea water, remote or off-grid), preconcentration, material purification and waste management (to either concentrate or dilute a product), semiconductor/chemical/pharmaceutical/oil/food/beverage industries, healthcare (biomarker/pH/ion sensing, dialysis), wearable/implantable devices (real-time health monitoring), battery and energy systems, real-time environmental monitoring, advanced fluid (flow/temperature sensing) and bio sensing. The apparatus 10 can also be used for applications for desalination or material purification at the locations with very scarce power source or material (e.g. space station, moon or mars).

As noted throughout, the apparatus 10 may be used in various GAA or MG configurations of the IEM gate 42. FIGS. 4A-4J are cross-sectional, diagrammatical illustrations of the ion exchange membrane of the desalination apparatus 10 of FIG. 2 positioned in various GAA or MG configurations, in accordance with embodiments of the present disclosure. Each example is shown with a rectangular cross-section of the gated region of microfluidic channel 40, but any cross-section shape may be used. As shown, FIGS. 4A-4F and 4J are MG configurations, but not GAA, due to partial coverage of all side-walls of the gated region of microfluidic channel 40, e.g., where some portion less than the entire circumference of the perimeter of the gated region of microfluidic channel 40 is covered, while FIGS. 4G-4I are in the GAA configuration, where the IEM gate 42 fully covers the entire perimeter of the gated region of microfluidic channel 40. In all examples, single or multiple electro-fluidic connections might be used to get connected to the side-walls of the IEM gates 42. It is noted that any GAA architecture may also be considered MG, but to classify an MG as a GAA, the IEM gates 42 must be present on all the side-walls of the gated region of microfluidic channel 40.

In the particular examples, FIG. 4A illustrates the dual-gate configuration of the IEM gate 42, where the IEM gate 42 is positioned on opposing sides of the gated region of microfluidic channel 40. FIG. 4B illustrates a fin-gate configuration, where the IEM gate 42 is positioned on three sides of the gated region of microfluidic channel 40. FIGS. 4C-4D illustrate a tri-gate configuration, where the IEM gate 42 is positioned on three sides of the gated region of microfluidic channel 40, with an electro-fluidic connection 44 associated with each side. FIGS. 4E-4J illustrate a quad-gate configuration, where the IEM gate 42 is positioned on four sides of the gated region of microfluidic channel 40. In FIGS. 4E-4G, an electrically biased electro-fluidic connection 44 or an electrically floated gate 56, as shown in FIG. 4F, is associated with each side, while in FIGS. 4H-4J, one or two electro-fluidic connections 44 may be used for the IEM gates 42. Other designs and configurations of GAA and MG usage of the IEM gate 42 may also be used, all of which are considered within the scope of this disclosure. In general, the IEM gate 42 may be placed on multiple side-walls (completely or partially on each side). The IEM gate 42 on each side-wall may be physically and electrically connected for dependent biasing or disconnected for independent biasing or floating.

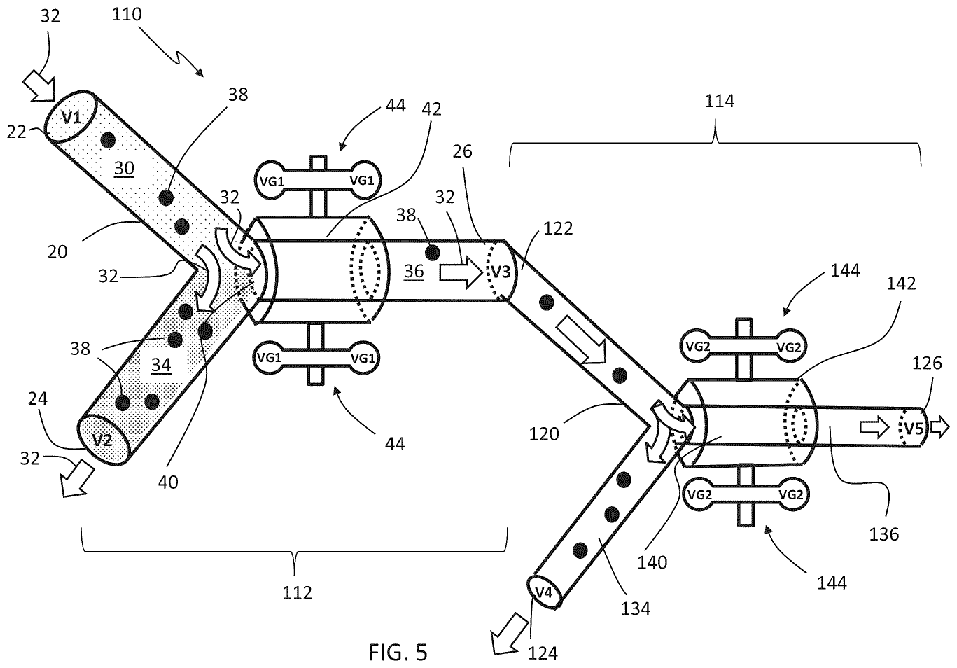

FIG. 5 is a side, diagrammatical illustration of a multi-stage desalination apparatus 110, in accordance with embodiments of the present disclosure. The desalination apparatus 110 may be similar to the apparatus 10 of FIGS. 2-3, but it includes a multi-stage operation where the apparatus 10 is used in series with itself. FIG. 5 depicts an example where a first stage 112 is used in series with a second stage 114. In operation, the first stage 112 operates as described relative to FIGS. 2-3, the description of which is not repeated for brevity in disclosure. Unlike described relative to FIGS. 2-3, the dilute 36 is received at the dilute outlet 26 the water may need further refinement, such as further desalination to remove ions and charged particles 38 which remain in the dilute 36. This dilute 36 is reintroduced to the inlet 122 of the second stage 114 where it flows along fluid pathway 120 until it is received at a second gated region of the microfluidic channel 140 having an IEM gate 142 and at least one electro-fluidic connection 144, where the water is processed a second time, using the same process and components as described relative to FIGS. 2-3.

With the second stage 114, the inlet 122 is electrically biased to the voltage of V3 and the gated region of the microfluidic channel 140 is electrically biased to the voltage of VG2. The concentrate brine outlet 124 is electrically biased to the voltage of V4. The dilute outlet 126 is electrically biased to the voltage of V5. By applying a specific voltage bias scheme to V3, V4, V5 and VG2, the gated region of microfluidic channel 140 may be considered fully depleted (FD), such flow of water can occur through the gated region of microfluidic channel 140, while the ions and charged particles in the sea water flow are repelled from the gated region of microfluidic channel 140 and they must go towards the concentrate brine outlet 124. The result is another concentrated brine 134 which is expelled through a second concentrate brine outlet 124, and a second, more refined dilute 136 which is output through a second dilute outlet 126.

A multi-stage apparatus 110 may be used when single-stage operation is not sufficient to remove all ions or charged particles from sea water, such that the output from the dilute 36 requires further desalination. This ‘stacking’ of various stages of the apparatus 10 may be continued to any number, such that the desired dilute is output at the end of all stages. It is noted that in the multi-stage operation, each stage may have, for example, a GAA-CEM or GAA-AEM, or a combination thereof. Each stage may or may not be electrically connected to the other stage. Each state may use either GAA or MG.

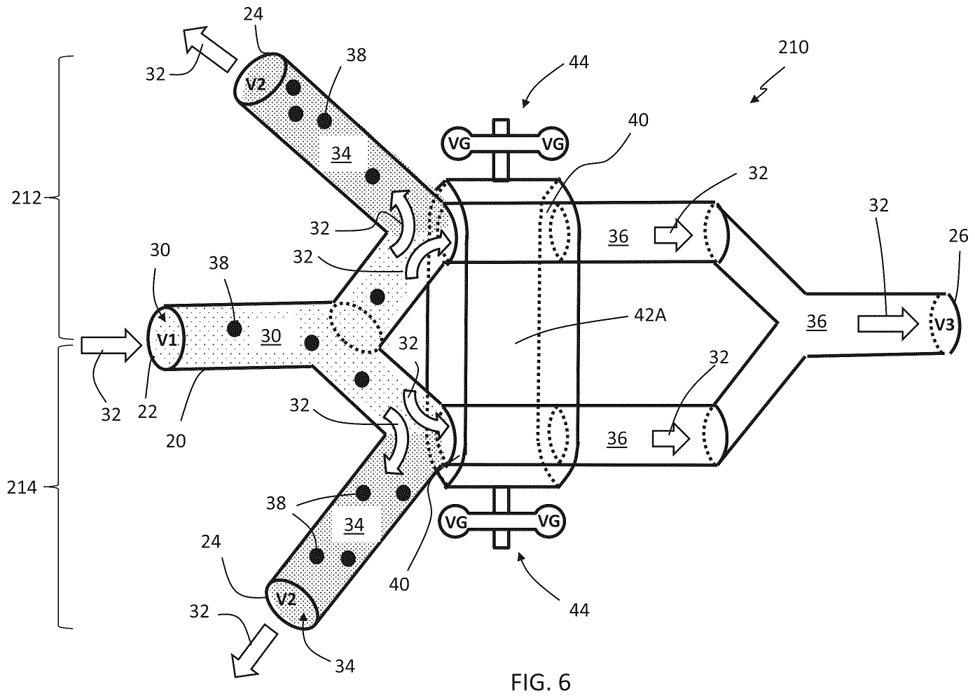

It may also be desirable to increase the net flow of dilute flow with a multi-stage operation in parallel. FIG. 6 is a side, diagrammatical illustration of a multi-stage desalination apparatus 210 in a parallel configuration, in accordance with embodiments of the present disclosure. The desalination apparatus 210 may have similar components to the apparatus 10 of FIGS. 2-3, the description of which is not repeated for brevity in disclosure, but it includes a multi-stage operation where two or more apparatuses 10 are configured in parallel. Specifically, the desalination apparatus 210 illustrates that it is possible to operate several MG or GAA desalination apparatuses 10 (FIGS. 2-3) in parallel, where the inlet 22 of each apparatus 10 is in fluid communication, and optionally, the outlet 26 is in fluid communication. Such a parallel configuration may include a first stage 212 is arranged in parallel with a second stage 214, with a common inlet 22 feeding both the first and second stages 212, 214, and a common dilute outlet 26 expelling dilute 36 from both the first and second stages 212, 214. Other examples may include multi-stage desalination apparatus 210 with more than two stages.

In operation, both the first and second stages 212, 214 receive salt water 30 at a common inlet 22, where the salt water 30 is directed along a fluid path in direction of flow path of arrows 32 to the microfluid channel 40 for each of the first and second stages 212, 214. As described relative to FIGS. 2-3, as the water flows through the microfluidic channel 40, electro-fluidic connections 44 at the IEM gate 42 for each stage may remove ions to allow dilute fluid 36 to pass to outlet 26. The operation may be substantially as described relative to FIGS. 2-3. The first and second stages 212, 214 may include separate IEM gates 42, or, as shown in FIG. 6, a common IEM gate 42A may be used. After output from the microfluid channels 40, the dilute 36 may be passed to a common dilute outlet 26, which would collect the dilute 36 flow from each stage 212, 214. While not depicted in FIG. 6, it is noted that a common concentrate brine outlet 24 may also be used to collect the concentrate brine 34 flow from each stage 212, 214. This type of parallel operation may include two or more devices.

FIGS. 7A-7C are illustrations of the desalination apparatus in accordance with exemplary experimentation. In particular, FIG. 7A illustrates the top view of a desalination apparatus 10 fabricated using polydimethylsiloxane (PDMS), silicon or the other materials. FIGS. 7B-7C illustrate cross-sectional views of FIG. 7A along the line A-A′ to show the gate architecture around the gated region of the microfluidic channel 40. Specifically, FIG. 7B depicts a three-gate device with double-grounding (multi-gate) while FIG. 7C depicts a four-gate device with double-grounding (gate-all-around).

Various fabrication methods may be employed to produce the desalination apparatuses disclosed herein, including, for instance, spin coating, thin-film deposition, etching, optical lithography, bonding, or other methods, and using a range of substrates such as glass, silicon, or polymers, all of which are considered within the scope of the present disclosure. All the desalination parts (inlets, outlets, gated regions) might be on a single wafer or might be a modular design to connect each component together e.g. using wafer bonding or the other methods to create the whole desalination device.

With reference to FIGS. 7A-7C, one example of a fabrication method which was used, in part, to demonstrate a low-cost and rapid method of manufacturing the apparatus includes fabricating PDMS desalination chips 300 using soft lithography to transfer the microfluidic device pattern from mold to PDMS, specifically, the PDMS device layer 302. Afterward, the PDMS device layer 302 was bonded to either PDMS or glass slide, which serves as the back layer 304. The molds may be prepared using an SLA 3D printer with a nominal 22 μm lithography resolution. To create the PDMS device layer 302, Dow SYLGARD™ 184 silicone may be mixed with the curing agent and poured into molds. After curing, the PDMS device layers 302 may be removed from the molds. The total thickness of PDMS device layer 302 may optimally be around 4 mm, but other thicknesses may be utilized, as dependent on the design. In this example, the channel cross-sections in the gated region of the microfluidic channel 40 cross-section were designed to be in the range approx. 44 μm×44 μm to approx. 154 μm×154 μm for width and thickness (nominal numeric values based on the mask dimensions).

To create the nanopore gates at the top and the sides of the microfluidic channel 40, a scalpel blade may be used to create a deep cut of around 1 mm nearby the Y intersection of the inlet 22 and the two outlets (concentrate brine outlet 24 and dilute outlet 26) in the PDMS device layer 302. It may be preferable for the cut to be long enough to reach the two side buffer channels at both sides of the microfluidic channel 40. Afterward, 0.5 μL of NAFION® 5% alcohol-based solution may be injected into the PDMS cut. The PDMS device layer 302 may then be cured, such as at 90° C. for 15 minutes to slowly evaporate the solvents in the NAFION® solution and to localize the NAFION® nanopore inside the PDMS. In this example, based on the optical microscope pictures, the width of the localized nanopore layer was in the range of approx. 1 μm.

To create the nanopore back-gate, a rectangular PDMS slab without any initial pattern may be prepared with the total PDMS thickness of approx. 4 mm. To create the back-gate, a PDMS cut, NAFION® injection into the cut and curing may be used, similar to the method for the PDMS device layer 302. After curing, the excess NAFION® residues on both PDMS device and PDMS back layers 304 may be removed using scotch tape. Afterward, a short ozone plasma treatment may be used on both PDMS layers (or a glass slide). The two PDMS layers may then be aligned precisely using optical microscope, and bonded together to create four-gate desalination devices 300B with double-grounding (gate-all-around), as shown in FIG. 7C. The three-gate desalination apparatus 300A with double-grounding may be fabricated by bonding the top PDMS layer, including top and side nanopore gates, to a glass slide or to a PDMS back layer 304 without any back-gate pattern. This is depicted in FIG. 7B.

The back-gate desalination device with double-grounding may be fabricated by bonding the top PDMS layer, without any nanopore gates, to a PDMS back layer 304 with the back-gate nanopore layer. This can be used as a reference device in the desalination experiments to segment the impact of gain on device characteristics, due to multi-gate or gate-all-around architectures.

While this exemplary fabrication uses low-cost methods, it is possible to use more sophisticated or state-of-the-art techniques such as optical lithography, thin film deposition, coating, etching, bonding or the other techniques to create either back-gate layer or the multi-gate/gate-all-around microfluidic layers. Therefore, the gate-all-around and multi-gate device architectures can be fabricated considering various ranges of microfluidic channel cross-sections, various nanopore gate conditions (width, length, thickness, CEM, AEM, various gate alignments to the Y intersection of the inlet 22 and the two outlets (concentrate brine outlet 24 and dilute outlet 26)), various angles of components (inlet 22, dilute outlet 26, concentrate brine outlet 24, IEM gates 42, grounding methods, electrode locations) and various orientations (such as vertical, horizontal or slanted). The IEM gates 42 on the top, bottom and sides of the channel can be self-aligned or with slight misalignment and each gate may have different dimensions (length, width, thickness). The used microfluidic channels can be PDMS, silicon, glass or the other materials.

The desalination chips 300 with channel cross-sections in the gated region of the microfluidic channel 40 of approx. 44 μm×44 μm (nominal numeric values based on mask) were used in the main desalination experiments. Salt and buffer solutions were injected at an inlet 22 of reservoir 310 and buffer solution inlets 312, respectively, to the desalination chip 300 using a digital pump at the flow rate of approx. 10 nL/min to 30 μL/min. Buffer solution outlets are identified in FIG. 7A at 314. A force DC voltage was applied to the sea water inlet by a Keithley 6487 pico-ammeter, using platinum microwires, and the electric current was measured. The both buffer channels were electrically grounded, using platinum microwires (double-grounding). The concentrate brine outlet 24 in the concentrate brine reservoir 316 and the dilute outlet 26 in the dilute reservoir 318 were electrically floated, e.g., not connected to any electrode, as labeled in FIG. 7A. Sodium phosphate solutions were used for the buffer channels (0.5M).

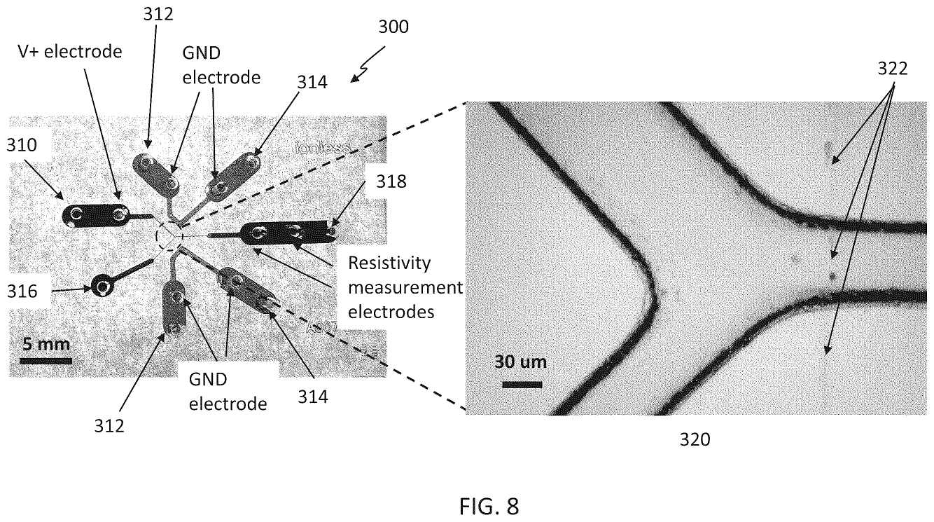

FIG. 8 is an illustration of a fabricated four-gate device with a localized nanopore within PDMS, in accordance with one example of the present disclosure. FIG. 8 may include components as previously described relative to FIGS. 7A-7C, and specifically, FIG. 8 simplifies general design of FIG. 7A by electrically biasing reservoir 310 with a V+ voltage and electrically ground all the buffer solutions 48. In addition, the salt concentration in the dilute reservoir 318 was estimated on-chip by a two-probe resistance measurement using platinum microwires. FIG. 8 further illustrates an enlarged portion 320, of the fabricated four-gate device depicting the localized nanopore within PDMS 322, in accordance with one example of the present disclosure.

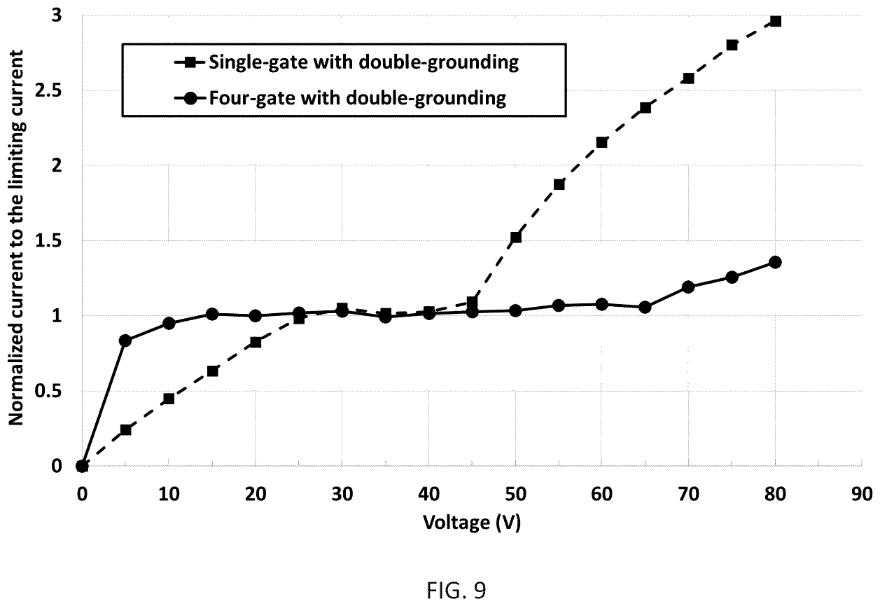

FIG. 9 is a graphical illustration depicting the normalized current to the limiting current versus voltage characteristics of a four-gate device versus a traditional single-gate device using an example at 0.6 g/L (˜600 ppm) of input salt solution at a flow of 9 μL/min and at room temperature. Both devices have double-grounding of buffer channels. Both devices have almost comparable limiting current numeric values (four-gate ˜1.4 μA, single-gate ˜1.7 μA). The device with increased number of gates shows much abrupter ionic diode current-voltage characteristics than the traditional single-gate device in the Ohmic region. In addition, by increasing the number of gates, the limiting current region gets formed at much smaller volage than the traditional single-gate device, due to ion depletion via the nanopore gates on multiple or all sides of the microfluidic channel instead of only via a single side of the microfluidic channel. The devices with more gates show more defined limiting current region and the limiting current region gets maintained over a much larger voltage range than the traditional single-gate device. This characteristic may translate into a significantly better electrostatic control on the ion depletion zone in the gated region of the microfluidic channel 40 (FIG. 2), simultaneously by multiple or all side-gates of the microfluidic channel in the multi-gate and gate-all-around architectures versus a single-gate device.

It is noted that the four-gate devices could desalinate higher concentration of input salt solution such as 34 g/L (˜34,000 ppm), as emulation of sea water, and the salt concentration in the dilute outlet could suppress down to the sub-500 ppm range, meeting the drinking water requirements, based on World Health Organization guidelines. Note that at higher input salt concentration, a higher voltage is required to create the limiting current region. To be able to reduce the desalination voltage, on top of optimizing the device geometry, operation, chemical, electrical, fluidic, measurement, temperature and other possible conditions, a multi-stage desalination might get used such as FIG. 5, performing partial desalination at each stage at a lower voltage until reaching the required salt concentration in the dilute outlet.

For the experiments, NAFION® was used as CEM to transport cations and therefore, a V+ voltage was applied to the inlet 22 and the buffer channels 46 were electrically grounded. In the case of doing the experiments using SUSTAINION® as AEM to transport anions, one bias scheme example can be electrically grounding the inlet 22 applying a V+ voltage to the buffer channels 46.

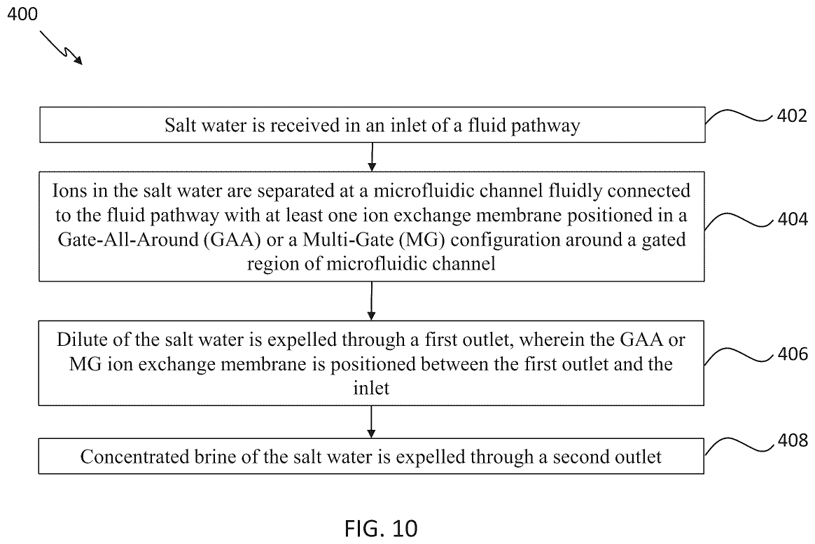

FIG. 10 is a flowchart 400 illustrating a method of desalination, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 402, salt water is received in an inlet of a fluid pathway. Ions in the salt water are separated at a microfluidic channel fluidly connected to the fluid pathway with at least one ion exchange membrane positioned in a Gate-All-Around (GAA) or a Multi-Gate (MG) configuration around a gated region of microfluidic channel (block 404). Dilute of the salt water is expelled through a first outlet, wherein the GAA or MG ion exchange membrane is positioned between the first outlet and the inlet (block 406). Concentrated brine of the salt water is expelled through a second outlet (block 408).

Any number of additional steps, functions, processes, or variants thereof may be included in the method, including any disclosed relative to any other figure of this disclosure. For example, the method may include at least one of: electrically biasing the inlet to a first voltage (V1); electrically biasing the second outlet to second voltage (V2); electrically biasing the first outlet to a third voltage (V3); or electrically biasing the gated region of the microfluidic to a fourth voltage (VG). In the GAA configuration, the method may include positioning the at least one ion exchange membrane fully surrounding the gated region of the microfluidic channel along a direction of fluid flow through the microfluidic channel. In the MG configuration, the method may include positioning the at least one ion exchange membrane surrounding at least two sides of the gated region of the microfluidic channel along a direction of fluid flow through the microfluidic channel. The method may utilize multi-stage operation, by directing the expelled concentrated brine of the salt water from the second outlet to an inlet of an in-series multi-stage desalination apparatus, or by use of an in-parallel multi-stage desalination apparatus. For instance, in the in-parallel multi-stage desalination apparatus, the method may include at least one of: receiving salt water in a common inlet of the fluid pathway; separating ions in the salt water with a common ion exchange membrane; expelling dilute of the salt water through a first common outlet; or expelling concentrated brine of the salt water through a second common outlet.

To further optimize the electric desalination performance, ion exchange resin (IER) may get integrated within or adjacent to ion depletion zone (IDZ), in the gated region of the microfluidic channel 40, within the fluid pathway 20, sea water inlet 22, concentrate brine outlet 24, or dilute outlet 26 (as shown in FIG. 2, for example). The ion exchange resins may be cation exchange resin (CER), anion exchange resin (AER) or both. They can be in the forms of beads, microparticles, structured porous composites or other forms. They may be implemented in multiple configurations such as CER only, AER only, mixed bed (mixed CER and AER), layered CER and layered AER, or the other arrangements. In case of using multi-stage or parallel stage, each stage can have its own configuration. The ion exchange resins may help to reduce the electric resistance between the electrodes by water splitting to form H+ and OH-ions to improve electric conduction.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A desalination apparatus comprising:
a fluid pathway having an inlet configured to receive salt water;
a microfluidic channel fluidly connected to the fluid pathway;
at least one ion exchange membrane positioned in a Gate-All-Around (GAA) or a Multi-Gate (MG) configuration around a gated region of microfluidic channel; and
at least first and second outlets of the fluid pathway, wherein the GAA or MG ion exchange membrane is positioned between the first outlet and the inlet, wherein dilute of the salt water is expelled through the first outlet and concentrated brine of the salt water is expelled through the second outlet.

2. The desalination apparatus of claim 1, wherein a direction of fluid flow along the fluid pathway from the inlet has an angle to a direction of fluid flow along the fluid pathway between the microfluidic channel and the second outlet.

3. The desalination apparatus of claim 1, wherein the inlet is electrically biased to a first voltage (V1), the second outlet is electrically biased to second voltage (V2), the first outlet is electrically biased to a third voltage (V3), and the gated region of the microfluidic channel is electrically biased to a fourth voltage (VG).

4. The desalination apparatus of claim 1, wherein in the GAA configuration, the at least one ion exchange membrane is positioned fully surrounding the gated region of the microfluidic channel along a direction of fluid flow through the microfluidic channel.

5. The desalination apparatus of claim 1, wherein in the MG configuration, the at least one ion exchange membrane is positioned surrounding at least two sides of the gated region of the microfluidic channel along a direction of fluid flow through the microfluidic channel.

6. The desalination apparatus of claim 1, wherein the microfluidic channel is constructed from at least one of: a polymer, a silicon, an oxide, or a nitride.

7. The desalination apparatus of claim 1, wherein a single bias voltage is applied to all side-walls of the at least one ion exchange membrane.

8. The desalination apparatus of claim 1, wherein a single bias voltage is applied independently to at least a portion of side-walls of the at least one ion exchange membrane.

9. The desalination apparatus of claim 1, wherein the at least one ion exchange membrane is formed from at least one of: a nanoporous material, a polymer thin films, a silicon nanostructure, a nanoporous organic structure, a nanoporous inorganic structure.

10. The desalination apparatus of claim 1, further comprising an electro-fluidic connection connected to the at least one ion exchange membrane, wherein the electro-fluidic connection has an internal buffer and at least one reservoir.

11. A multi-stage desalination system comprising:
a first desalination apparatus in fluid communication with a second desalination apparatus, each of the first desalination apparatus and second desalination apparatus having:
a fluid pathway having an inlet configured to receive salt water;
a microfluidic channel fluidly connected to the fluid pathway;
at least one ion exchange membrane positioned in a Gate-All-Around (GAA) or a Multi-Gate (MG) configuration around a gated region of microfluidic channel; and
at least first and second outlets of the fluid pathway, wherein the GAA or MG ion exchange membrane is positioned between the first outlet and the inlet, wherein dilute of the salt water is expelled through the first outlet and concentrated brine of the salt water is expelled through the second outlet.

12. The multi-stage desalination system of claim 11, wherein dilute of the salt water expelled through the first outlet of the first desalination apparatus is directed into the inlet of the second desalination apparatus.

13. The multi-stage desalination system of claim 11, wherein at least one of the inlet, the first outlet, or the second outlet of the first desalination apparatus is fluidly connected to the inlet, the first outlet, or the second outlet of the second desalination apparatus, respectively.

14. The multi-stage desalination system of claim 11, wherein the at least one ion exchange membrane of the first desalination apparatus and the second desalination apparatus further comprises a common ion exchange membrane used by both the first desalination apparatus and the second desalination apparatus.

15. A method of desalination comprising:
receiving salt water in an inlet of a fluid pathway;
separating ions in the salt water at a microfluidic channel fluidly connected to the fluid pathway with at least one ion exchange membrane positioned in a Gate-All-Around (GAA) or a Multi-Gate (MG) configuration around a gated region of microfluidic channel;
expelling dilute of the salt water through a first outlet, wherein the GAA or MG ion exchange membrane is positioned between the first outlet and the inlet; and
expelling concentrated brine of the salt water through a second outlet.

16. The method of desalination of claim 15, further comprising at least one of:
electrically biasing the inlet to a first voltage (V1);
electrically biasing the second outlet to second voltage (V2);
electrically biasing the first outlet to a third voltage (V3); or
electrically biasing the gated region of the microfluidic to a fourth voltage (VG).

17. The method of desalination of claim 15, wherein in the GAA configuration, positioning the at least one ion exchange membrane fully surrounding the gated region of the microfluidic channel along a direction of fluid flow through the microfluidic channel.

18. The method of desalination of claim 15, wherein in the MG configuration, positioning the at least one ion exchange membrane surrounding at least two sides of the gated region of the microfluidic channel along a direction of fluid flow through the microfluidic channel.

19. The method of claim 15, further comprising directing the expelled concentrated brine of the salt water from the second outlet to an inlet of a multi-stage desalination apparatus.

20. The method of claim 15, further comprising at least one of:
receiving salt water in a common inlet of the fluid pathway;
separating ions in the salt water with a common ion exchange membrane;
expelling dilute of the salt water through a first common outlet; or
expelling concentrated brine of the salt water through a second common outlet.
